(19) United States
(12) Patent Application Publication
(10) Pub. No.: US 2004/0153292 A1
(43) Pub. Date: Aug. 5, 2004

(54) Detecting a significant event in experimental data and use of such for detection of engagement during a mechanical test

(75) Inventor: Jennifer Hay, Knoxville, TN (US)

Correspondence Address: Linda P. Ji, Westman, Champlin & Kelly, Suite 1600, 900 Second Avenue South, Minneapolis, MN, 55402-3319, US

(73) Assignee: MTS Systems Corporation, Eden Prairie, MN

(21) Appl. No.: 10/770,074

(22) Filed: Feb. 2, 2004

Related U.S. Application Data
(60) Provisional application No. 60/444,446, filed on Feb. 3, 2003.

(51) Int. Cl. G06F 15/00

(52) U.S. Cl. 702/189

(57) ABSTRACT

A method of determining onset of a significant event, such as point of engagement, in experimental data such as data measured during indenter or tensile/compression tests. The measured data is processed by differentiation and/or integration to generate a plurality of processed series. The method includes setting an upper bound and a lower bound based on thresholds selected as multiples of a standard deviation. The significant event is determined from one or both of the upper and lower bounds. The method can include calculating an uncertainty for the significant event determination.

The present application is based on and claims the benefit of U.S. provisional patent application Serial No. 60/444,446, filed Feb. 3, 2003, the content of which is hereby incorporated by reference in its entirety.

### BACKGROUND OF THE INVENTION

Sensitive, accurate, and consistent detection of significant events in experimental data is an important capability for a myriad of applications. For example, in experiments or tests that measure mechanical properties of materials, it is often important to measure a significant event known as the engagement point. For contact-type tests used typically to measure a mechanical property such as hardness, and which typically utilize an indenter, the engagement point is the point at which the indenter first contacts and begins to apply force to the test surface. For tensile tests measuring, for example, stress and strain, the engagement point is the point at which all slack has been removed from the test apparatus and test sample, and any further movement in the same direction begins to stress and strain the test sample. In another example, it can be desirable to detect changes in temperature from a baseline in a particular process or environment. Often it is difficult to detect a significant event using a simple threshold, especially when measurement changes are gradual. A system and method of accurately, sensitively, and consistently detecting significant events in experimental data would have significant utility.

### SUMMARY OF THE INVENTION

One aspect of the present invention includes a computer readable medium that includes computer executable instructions for detecting a significant event in measurement data. Measurements are processed to calculate values indicative of multiples of a standard deviation. The point of onset of the significant event is calculated as a function of the calculated values.

Another aspect of the present inventions also includes detecting the significant event by receiving a data series indicative of test measurements as a function of a variable. At least one processed series is generated from the data series. A first point and a second point are identified on at least one of the processed series. The significant event is then calculated based on at least one of the two points.

Other aspects of the present invention also includes associated methods and testing systems adapted to determine a significant event using methods of the present invention described herein.

### BRIEF DESCRIPTION OF THE DRAWINGS

FIG. 1 is a schematic diagram of an environment where the present inventions can be practiced.

FIG. 2 is a schematic diagram of a computing environment useful in practicing the present inventions.

FIG. 3 illustrates a block diagram of an embodiment of the present inventions and illustrates broad concepts helpful in understanding the present inventions.

FIG. 4 illustrates a block diagram of an aspect of the present invention.

FIG. 5 is a flowchart illustrating a method in accordance with an aspect of the present invention.

FIG. 6 is a graph of measured force as a function of displacement.

FIG. 7 is a graph of a second derivative of the graph illustrated in FIG. 6.

FIG. 8 is a graph of processed signals as a function of time generated in accordance with the present inventions.

FIG. 9 is an enlargement of FIG. 6 and illustrates a point corresponding to a significant event calculated in accordance with the present inventions.

### DETAILED DESCRIPTION OF THE PREFERRED EMBODIMENTS

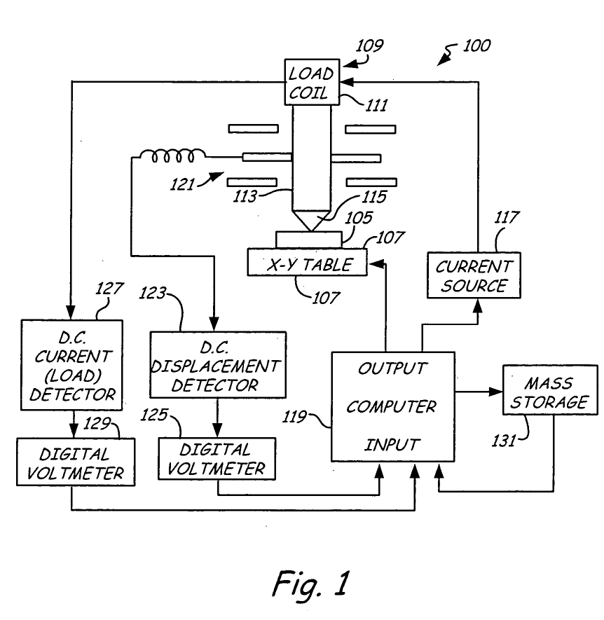

Referring now to FIG. 1, there is shown a schematic diagram of a testing system, such as an indenter testing system used to measure mechanical properties of materials. Testing system 100 is modified in accordance with the present inventions for testing a sample of material 105.

Sample 105 is placed at a known location on computer controlled X-Y table 107 with the surface to be tested facing up. Electromagnetically driven indenter arrangement 109 is provided, which is positioned over the sample 105. Indenter 109 includes current driven load coil 111 activated by the application of electrical current from computer controlled variable current source 117 to move the probe tip 115 downward into contact with sample 105. Once tip 115 contacts sample 105, a pre-selected force pattern is applied to indenter 109 by the programmed variation of the current applied to drive coil 111. In some embodiments, probe tip 115 can be in the form of a typical triangular pyramidal diamond probe with an end radius of about 500 Angstroms.

Current source 117 is controlled by system computer 119 , which also controls X-Y table 107. Displacement of probe 113 is measured by capacitive displacement gage 121 , whose output is connected to DC displacement detector 123. Detector 123 digitizes the DC displacement signal, which is fed through a first digital voltmeter 125 to an input of computer 119 for further processing in accordance with the present inventions. Voltmeter 125 can provide a calibrated readout of probe displacement to an operator during testing procedures, if desired.

Force applied to sample 105 through indenter probe 115 is monitored by DC current detector 127, which senses the DC drive current applied to load coil 111. The DC load current is digitized by detector 127 and fed through a second digital voltmeter 129 to a further input of computer 119 for further processing according to the present inventions. In some embodiments, computer 119 can be connected to a mass storage device 131 where data and system operating parameters are stored.

Using testing system 100 as described above, a sample 105 is positioned at a known location on X-Y table 107 and programmed computer 119 is signaled to start a timed test and data gathering procedure. Generally, computer 119 is programmed to perform one or more prescribed indentation tests by automatically causing single or multiple indentations at designated locations on sample 105. Probe 115 is lowered at a very slow rate until contact is made with sample 105.

During the test procedure, computer 119 records measurement data, such as force taken from DC current (load) detector 127 and probe displacement taken from DC displacement detector 123. Measurement data can be used later to determine mechanical properties of sample 105. Additionally, measurement data such as values associated with measured force, displacement, and time can be processed using the present inventions to determine significant events occurring during the test procedure, such as when probe tip 115 “engages” sample 105 during the indentation procedure.

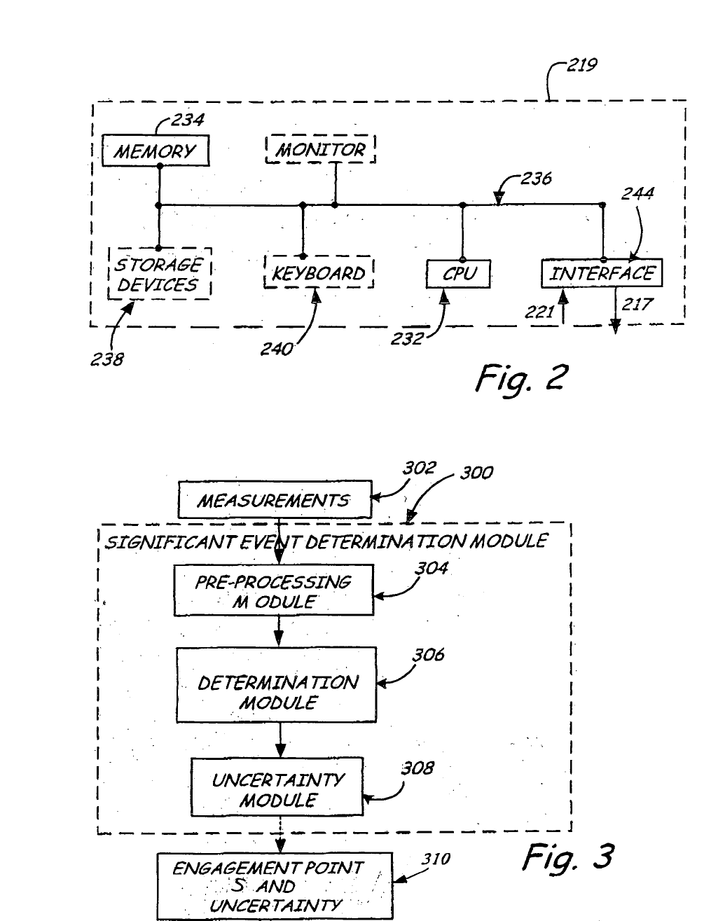

FIG. 2 and the related discussion provide a brief, general description of a suitable computing environment in which the present inventions can be implemented. Although not required, testing system 100 and the present inventions can be described, at least in part, in the general context of computer-executable instructions, such as program modules, being executed by computer 119, 219. Generally, program modules include routine programs, objects, components, data structures, etc., which perform particular tasks or steps or implement particular abstract data types of the present inventions. Program modules and associated methods are described below and illustrated using block diagrams and flowcharts. Those skilled in the art can implement the block diagrams and flowcharts to computer-executable instructions. Moreover, those skilled in the art will appreciate that the inventions may be practiced with other computer system configurations, including multi-processor systems, networked personal computers, mini computers, main frame computers, and the like. The inventions may also be practiced in distributed computing environments where tasks are performed by remote processing devices that are linked through a communications network. In a distributed computer environment, program modules may be located in both local and remote memory storage devices.

Computer 219 illustrated on FIG. 2 (similar to computer 119 illustrated on FIG. 1), comprises a conventional personal or desktop computer having central processing unit (CPU) 232, memory 234 and system bus 236, which couples various system components, including memory 234 to CPU 232. System bus 236 may be any of several types of bus structures including a memory bus or a memory controller, a peripheral bus, and a local bus using any of a variety of bus architectures. Memory 234 includes read only memory (ROM) and random access memory (RAM). A basic input/output (BIOS) containing the basic routine that helps to transfer information between elements within computer 230, such as during start-up, is stored in ROM. Storage devices 238, such as a hard disk, a floppy disk drive, an optical disk drive, etc., are coupled to system bus 236 and are used for storage of programs and data. It should be appreciated by those skilled in the art that other types of computer readable media that are accessible by a computer, such as magnetic cassettes, flash memory cards, digital video disks, random access memories, read only memories, and the like, may also be used as storage devices. Commonly, programs are loaded into memory 234 from at least one of storage devices 238 with or without accompanying data.

Input device 240 such as a keyboard, pointing device (mouse), or the like, allows a user to provide commands to computer 230. Monitor 242 or other type of output device is further connected to system bus 236 via a suitable interface and provides feedback to a user.

Control signals 217 output to testing system 100 comprising current source 117 and X-Y table 107 (illustrated in FIG. 1) based on program modules executed by computer 119, 219 and through suitable interface 244. Interface 244 receives output signals 221 indicative of displacement from voltmeter 125 and signals 221 indicative of force from voltmeter 129. Response signals 221 are processed based on program modules executed by computer 119, 219 to calculate or approximate, for example, material properties or significant events occurring during the testing procedure, such as engagement point.

FIG. 3 illustrates a block diagram of an embodiment of the present invention, which can be implemented with a computer such as computer 119, 219 executing instructions stored on a computer-readable medium. Modules, sub-modules, and associated steps for carrying out such instructions are described below. Those skilled in the art will readily understand that the illustrated modules, sub-modules, and steps can be combined or divided as desired. It is noted, that all steps of the present inventions can be performed after the test procedure or experiment is completed. Optionally, some steps can be performed during the actual test procedure. Also, variables x, y, z, t, etc. all represent series of values that are controlled, sensed or measured during the test procedure or experiment, or series that are calculated or derived from such. Examples of such series include force y, displacement x, time t, reading number, stress, strain, flow rate, temperature, and the like. It should be noted that x, y, z, and t may actually represent any experimental series. It should further be noted that x, y, z, and t can each be independent or dependent series. For example, in a testing system that measures mechanical properties of materials, where force is controlled and displacement is a sensed response, y can represent force and t can represent displacement. Finally, it should be noted that each time the order (n) changes, the series represented by t may also change.

In FIG. 3, broad modules or steps that are helpful in understanding the present inventions are illustrated. Testing system 100 (illustrated on FIG. 1) generates signals indicative of measurements, variables, or data 302 such as x, y, z, t described above. Measurements 302 are received as input to significant event determination module 300, which comprises pre-processing module 304, determination module 306, and optionally, uncertainty module 308. Pre-processing module 304 receives and processes measurements 302 in accordance with the present inventions to generate values used by determination module 306 to determine or detect events that are significant, such as engagement point S of probe tip 115 and sample 105 (illustrated on FIG. 1). Notably, such an engagement point has values associated with variables such as force, displacement, and time at engagement. Significant event determination module 300 generates measurements or values for the variables or parameters at engagement point S, and optionally, an uncertainty as indicated at 310.

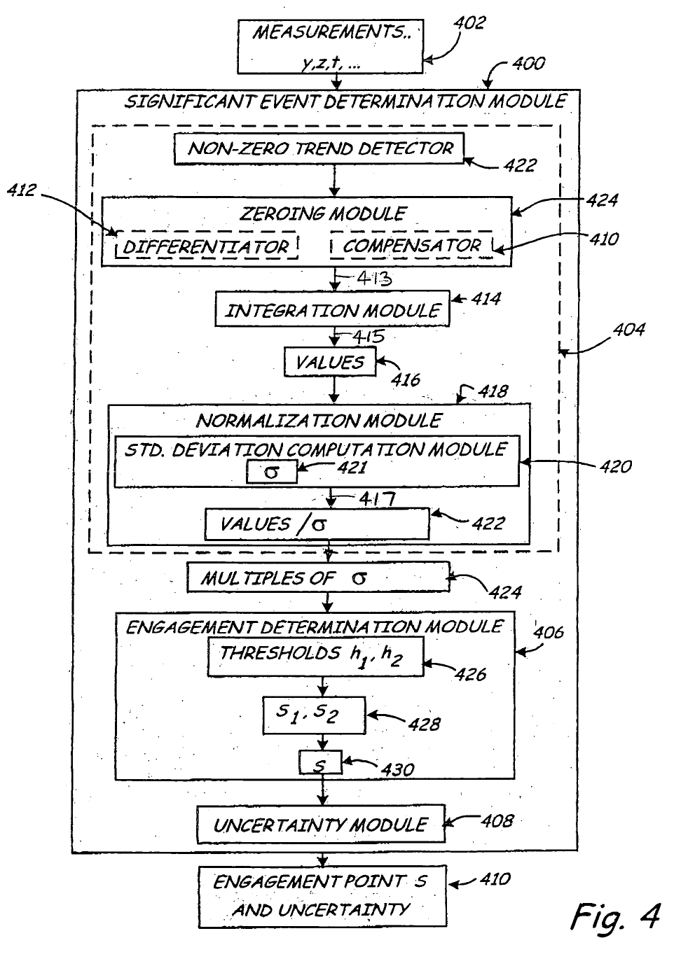

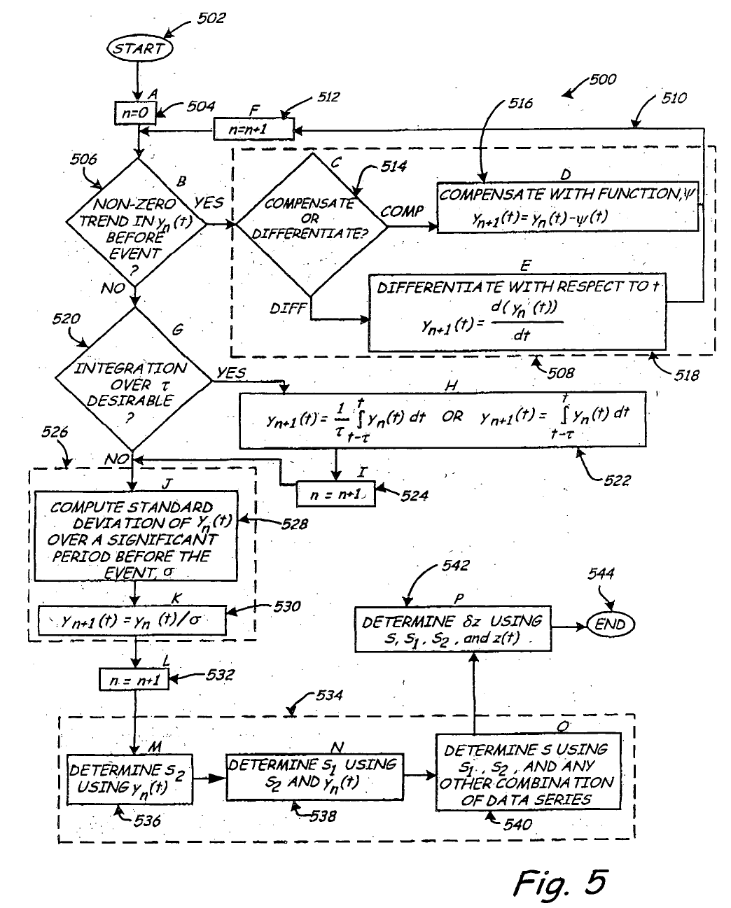

FIG. 4 illustrates an embodiment of the present invention and generally illustrates greater detail than the embodiment illustrated in FIG. 3. For convenience, the last digits of the reference numerals in FIGS. 3 and 4 correspond where possible (such as 302, 402 ) to indicate similar items or steps. FIG. 5 illustrates a flowchart of an algorithm or method 500 of the present invention. The blocks in FIG. 5 are labeled with letters “A” through “P” generally indicating steps of one or more methods. However, it should be noted that the indicated steps and their respective order are illustrative only and can be combined, recombined, divided, or reordered as desired.

Testing system 100 (illustrated on FIG. 1) generates values associated with or indicative of measurements or data 302, 402. Measurements 302, 402 are provided to or received by significant event determination module 400. FIG. 5 generally illustrates a step of receiving measurements as start block 502 and block 504 where the series order, n is initialized.

Significant event determination module 400 includes non-zero trend detector 422, which is adapted to or capable of detecting trends in measurements 302, 402. FIG. 5 illustrates a step of detecting a non-zero trend in received measurements at block 506. Significant event determination module 400 can also include pre-processing module 404, shown in dotted lines, that corresponds to pre-processing module 304 (illustrated in FIG. 3). Detector 422 can use any known means such as mathematical methods, electronic methods, curve fitting, etc. to detect a slope, change, or non-zero trend in measurements 302, 402, especially prior to the significant event to be detected. Measurements 302, 402 can include variables such as force recorded or measured as a function of at least one other variable such as displacement and/or time. In some embodiments, force is a controlled variable and displacement is a response variable being measured.

Generally, non-zero trends can be caused by the physical environment or the testing system itself. For example, a load cell may have some known offset, for example, 5 mN. Another example is a linear relationship between force and displacement, which can exist due to internal stiffness of testing system 100. In the examples provided, both the offset in force of 5 mN and the internal stiffness cause a non-zero trend before the onset of the significant event or engagement point. In the present inventions, an initial non-zero trend in a data measurement signal is processed by “zeroing” or generating at least one processed signal or series that scatters or fluctuates about zero.

In contrast, if non-zero trend detector 422 does not detect a non-zero trend, i.e. measurements 302, 402 are scattered about zero as a function of another variable, such as displacement or time, then measurements 302, 402 can be provided to integration module 314 directly. However, if non-zero trend detector 422 detects a pre-significant event non-zero trend in measurements 302, 402, then measurements 302, 402 are provided to zeroing module 424 for further processing. FIG. 5 illustrates a step of zeroing at block 508, which is indicated with dotted lines. The step of zeroing can be iterative as indicated at 510. The series order is advanced with each loop, pass, or iteration through zeroing module 508 as indicated at block 512.

Zeroing module 424 comprises compensator 410 and/or differentiator 412 that are used to process or generate a new series or signal output that approximates or scatters about zero. Compensator 410 or differentiator 412 is user selectable based on design criteria as illustrated at compensation/differentiation selection block 514 illustrated in FIG. 5. In embodiments utilizing compensation, compensator 410, (assuming variable y is a function of t) constructs a new series by “compensating” values (generally, but not limited to, all values) of measurements 302, 402 using an analytic function Ψ(t). FIG. 5 illustrates compensation at compensation block 516. The function Ψ(t) can be known from the physical environment or it may be determined by methods such as curve fitting within some significant pre-event period using, for example, a low-order polynomial function or some other appropriate form.

Therefore, in the above example where a load cell contains a 5 mN offset or Ψ(t)=5 mN, compensator 410 constructs a new or processed series such as y₁(t) where y₁(t)=y₀(t)−Ψ(t)=y₀−5 mN. In the second example where a linear relationship exists between y₀(t) and displacement t, then a linear fit to pre-event data produces the linear function Ψ(t) where Ψ(t)=kt+b, k is slope, and b is the constant at t=0. Compensator 410 constructs or generates a new series y₁(t) where y₁(t)=y₀(t)−Ψ(t), or y₁(t)=y₀(t)−kt−b.

In embodiments illustrative of differentiation, differentiator 412 takes successive derivatives, usually up to a first or second derivative to construct at least one new or processed series scattering about zero. Thus, in the above example where a load cell has a 5 mN offset, series y₀(t) is approximately equal to 5 mN, and differentiator 412 generates a new series y₁(t) from y₀(t) by taking a first derivative of y₀(t) so that y₁(t)=y₀′(t)=0. Thus, the new series y₁(t) now scatters about or is approximately zero. In the second example where a linear relationship exists between y₀(t) and displacement t, then series y₀(t) can be expressed as y₀(t)=kt+b, where k is slope and b is a constant as above. On a first iteration through differentiator 412 (illustrated as differentiation block 518 on FIG. 5), differentiator 412 takes a first derivative of y₀(t) to generate a new or first processed series y₁(t), where y₁(t)=y₀′(t)=k. This means that series y₁(t) scatters about k after a first pass through differentiator 412. Differentiator 412 then loops and generates a second derivative of y₀(t), or a second processed series Y₂(t) where y₂(t)=y₁′(t)=y₀″(t)=0.

Thus, in the second example two loops or passes through differentiator 412 are needed to generate or construct series Y₂(t) scattering or fluctuating about zero. It should be noted that differentiation can be accomplished by any known means, including but not limited to numerical methods, electronic methods, or curve fitting. In many instances, it can be advantageous to use differentiation versus compensation. For example, with differentiation, it is not generally necessary to know the underlying functionality of series variable yₙ, e.g. it is not necessary to know the load offset, or precise linear relationship between y and t. It should also be noted that there can be a pre-event quadratic, cubic, or higher order polynomial relationship between y and t, which would seemingly call for third, fourth, and higher order derivative to generate a processed series scattering about zero. However, taking successive derivatives generally results in greater signal instability, which effectively limit the number of derivatives that can be taken.

In another embodiment, both differentiation and compensation can be used to zero input measurements. Thus, assuming there is a quadratic relationship between two variables such as force y and displacement t, then initially, y₀ can be expressed as y₀=at²+bt+c where a, b, and c are constants. Taking iterative first and second derivatives of y₀ yields y₂(t)=y″(t)=c. Compensation can then be used where Ψ(t)=c so that new series y₃(t)=0. Thus, compensation and differentiation can be combined, especially to limit signal instability when a derivative greater than a second derivative is needed to zero input measurements.

Zeroing module 424 outputs or generates processed series yₙ also called zeroed or “derivative signal” 413 where at least a portion of the derivative signal scatters about zero, especially pre-event data. It is important to reiterate, however, that there are situations where input measurements 302, 402, especially pre-event data, scatter about zero and are, therefore, not in need of compensation or differentiation. Thus, derivative signal 413 is intended to include a series, new or original, that scatters about zero with or without differentiation or compensation. Derivative signal 413 is provided to or received by optional integration module 414 for further processing. The flowchart of FIG. 5 illustrates that integration is optional at block 520. However, in most situations integration is needed to implement the present inventions. In embodiments where integration is selected, integration module 414 generates or constructs new series Yₙ₊₁(t) also called “integral signal” 415 by integrating series yₙ with respect to t over a selected increment or period τ. FIG. 5 illustrates the step of integration at integration block 522, which advances the series order at block 524. The processed series yₙ₊₁(t) generated by integration module 414 can be computed as follows:

$${y}_{n + 1} ( t ) = {\int }_{t - τ}^{t} {y}_{n} ( t ) ⅆ t . \qquad Eq . 1$$

Thus, the series yₙ₊₁(t) generates values indicated at 416 for any value of t. It is noted that integration can significantly increase sensitivity to significant event onset, especially over some previous period τ, because gradual changes are cumulative or accumulated.

In integration module 414 a period τ can be selected so that τ is several times greater than the period in which detection is desired. For example, if t represents time and detection is desired within 1 second, then τ could be selected around 5 seconds. If τ is set too large, the small offsets in yₙ may be accumulated, and yₙ₊₁(t) may not be centered about zero.

Optionally, integration module 414 can compute values 416 using the following equation:

$${y}_{n + 1} ( t ) = \frac{1}{τ} {\int }_{t - τ}^{t} {y}_{n} ( t ) ⅆ t , \qquad Eq . 2$$

which can be viewed as the mathematical expression of mean values of yₙ(t) over the previous period, τ. Integration can be accomplished by several known means, including but not limited to, numerical methods, electronic methods, or curve fitting.

Integral signal 415 having values 416 generated by integration module 414 are then output to or received by normalization module 418, which is indicated at normalization block 526 on FIG. 5. It should be noted that normalization module 418 generates the same results on output signal 417 regardless of whether above Eq. 1 or Eq. 2 is used in integration module 414. Normalization module 418 comprises standard deviation computation module 420, which computes or generates standard deviation σ 421 for series or values 416 of integral function 415 over some period (typically a significant interval) before the significant event. FIG. 5 illustrates computing standard deviation a 421 at block 528.

Normalization module 418 processes or generates a new series yₙ₊₁(t) by dividing all values 416 in series yₙ by standard deviation σ as indicated at 422. FIG. 5 illustrates the step of dividing yₙ by the standard deviation σ at block 530 to advance the series order as indicated at block 532. Thus, the output of normalization module 418 are values 424 that are dimensionless and multiples of the standard deviation σ. These values 424 can then be used to detect events such as the point of engagement. Thus, significant events are calculated or determined as a function of these values 424 that are indicative of standard deviation, especially multiples of the standard deviation.

Normalization module 418 outputs values 424 that are received by determination module 306, 406. FIG. 5 illustrates the broad step of event determination at block 534 indicated as dotted lines and comprising several sub-blocks 536, 538, and 540. Engagement determination module 306, 406 comprises user selected threshold settings h₁ and h₂ as indicated at 426. The threshold setting h₁ is selected as a lower bound to indicate that the significant event has not yet occurred. The threshold setting h₂ is selected to indicate an upper bound or a point where the significant event is assumed to have already occurred. It is generally desirable to set threshold setting h₂ in consideration of a desired confidence level. Generally, if the pre-event distribution of yₙ(t) is approximately Gaussian, then a threshold setting h₂ in the range of 10 and 20 (i.e. where values 424 are between 10 and 20) yields good results. As with h₂, threshold setting h₁ should be set in consideration of the desired confidence level. Generally, selecting a threshold setting h₁ at a value less than 1 (i.e. where values 424 are less than 1) yields good results.

Engagement determination module 406 then uses threshold settings h₂ and h₁ to determine points S₂ and S₁ respectively, as indicated at 428. The point S₂ is determined using a processed series yₙ(t) and threshold h₂. S₂ is the first point in the series yₙ(t) for which there is excellent evidence for the onset of the event. Thus, S₂ is the first point, actual or interpolated, for which yₙ(t) differs from zero by a threshold, h₂. Thus, if the threshold h₂ is set at 15, then the point S₂ occurs where the value of yₙ(t) first exceeds 15. Once S₂ has been determined, it can be associated or correlated with points in other data series of the experiment.

Point S₁ is then determined starting with the point S₂ and stepping back through values in the series yₙ(t). Point S₁ is the first encountered point, actual or interpolated, for which yₙ(t) is within a given absolute-value threshold setting, h₁. Absolute values are used because values for series yₙ(t) can be positive and negative in some situations. FIG. 5 illustrates steps of determining points S₂ and S₁ at block 536 and block 538, respectively.

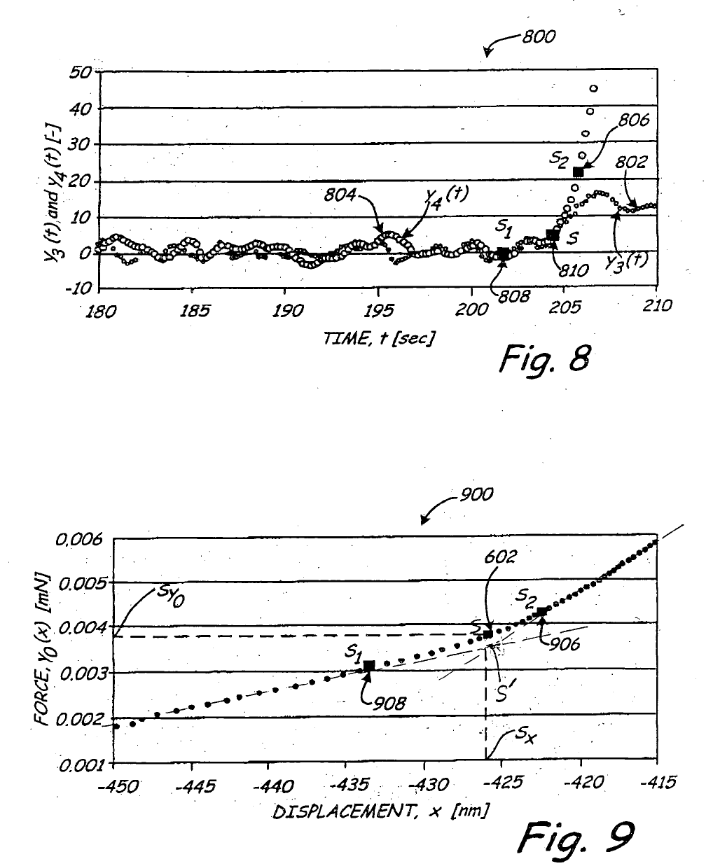

Determination module 306, 406 calculates an event such as engagement, herein denoted as point S or S′ (illustrated in FIGS. 8 and 9 ) using S₁, S₂, and any combination of data series. FIG. 5 illustrates the step of calculating S, S′ at block 540. Calculation of S, S′ may be accomplished in any number of ways. For example, it can be sufficient to set S to be the same point as S₂, or S can be calculated to be the first actual or interpolated point after S₁, for which yₙ(t) differs from zero by a less stringent threshold hₛ of, say, 4. It should be noted that in alternate embodiments, engagement point denoted as S′ does not necessarily have to lie on a particular experimental trace z(t). For example, if z represents force and t represents displacement, it may be useful to calculate S′ as the unique intersection point of linear extrapolations of z(t) data before S₁ and after S₂ (as illustrated as intersection point S′ on FIG. 9) in which case, S′ may have associated values of force and displacement that are not actual measured values. Once S (or S′) has been determined, it can be corresponded with values in other data series for the experiment, such as temperature. FIG. 5 illustrates the step of determining S at block 540.

Significant event determination module 400 can include uncertainty module 308, 408 to calculate uncertainty δz. The step of determining uncertainty is illustrated as block 542 on FIG. 5. Uncertainty δz is the uncertainty in any sensed, response, controlled, or calculated series due to the uncertainty in the point of onset of the event. Calculation of δz can be accomplished any number of ways. A conservative estimate of δz might be obtained by calculating half the variation in z between S₁ and S₂. Thus, uncertainty can be calculated as a function of S₁ and S₂. If extrapolations are used to obtain S, uncertainties can be based on uncertainties in the fitted coefficients of the extrapolations. Significant event determination module 400 generates engagement point S and uncertainty δz as indicated at 410, and illustrated at end block 544 on FIG. 5, that are then available to a user and/or for further processing.

### AN EXAMPLE

To demonstrate the present inventions, a hardness test was performed using a testing system similar to testing system 100 illustrated in FIG. 1. Although not required, such a testing system can include a computer-controlled AC signal generator fed to current source 117 and an AC displacement detector in line between capacitive displacement gage 121 and computer 119. Such a testing system has been referred to as a Nanoindenter XP, which is manufactured by MTS Systems Corporation of Eden Prairie, Minn. and described in U.S. Pat. No. 4,848,141, which is herein incorporated by reference. Although not illustrated, a similar test procedure can be performed on a tensile testing system such as described in U.S. Pat. No. 6,679,124, herein incorporated by reference in its entirety. In the context of a hardness test, the “significant event” of interest is engagement between an indenter or probe tip 115 and the surface of a test sample such as sample 105. Force (y₀), displacement (x), and time (t) were recorded during the initial part of a hardness test on polycarbonate before, during, and after engagement or contact. Polycarbonate was chosen because it is a rather compliant material, which makes engagement detection more challenging.

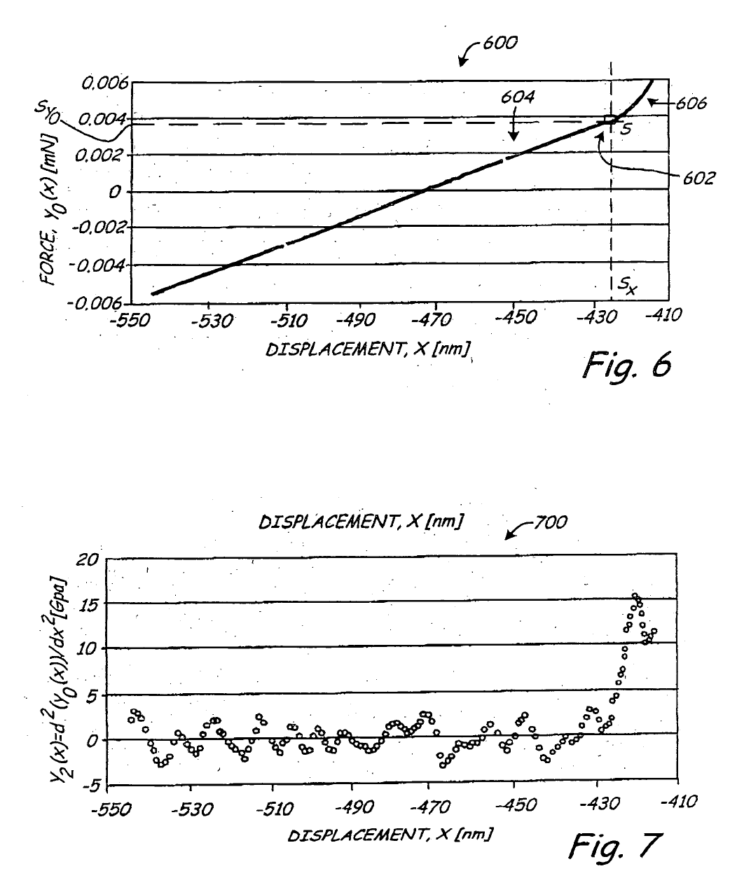

FIGS. 6-9 are pictorial graphs that illustrate results of a test procedure performed in accordance with the present invention. However, it should be noted that although pictorial graphs are helpful in understanding aspects of the present invention and can be rendered if desired to the user, pictorial graphs are not necessary for processing data associated with a significant event. FIG. 6 is a graph 600 that illustrates measurements of force (mN) as a function of a variable displacement (nm). Both force, displacement, and time measurements were recorded during the test procedure and received by a computer such as computer 119, 219 (illustrated on FIGS. 1 and 2, respectively) for further processing in accordance with the present inventions. Graph 600 illustrates point S, indicated at 602, which is the calculated engagement point according to the present inventions. To the left of S as indicated at 604, there is no engagement. To the right of S as indicated at 606, the probe tip is engaged with the sample.

In order to obtain a series that is scattered about zero before contact, a plurality of new or processed series were generated by taking a first derivative and then a second derivative of force with respect to displacement. The second derivative was calculated using the following equation:

$${y}_{2} ( x ) = \frac{{ⅆ}^{2} ( {y}_{0} ( x ) )}{ⅆ {x}^{2}} . \qquad Eq . 3$$

It is noted that the notation y₂(x)=y₀″(x) used above is equivalent to the notation in Eq. 3. FIG. 7 is a graph 700 illustrating the results for new series y₂(x) plotted as a function of displacement x using Eq. 3. The differentiation was performed numerically using any point of interest and several data points backward (to the left). In this context, repeated differentiation is advantageous because it can be done in real-time with no a priori information regarding the pre-engagement functional relationship between force and displacement. (In other words, one doesn't need to know the offset or the stiffness of the testing instrument.) The disadvantage is that repeated numerical differentiation of experimental data tends to produce series that are progressively more “scattered.”

FIG. 8 is graph 800 illustrating series y₃ and y₄ as a function of another variable time t rather than displacement x. In order to illustrate the advantage of integration such as illustrated by integration module 414 on FIG. 4 and block 522 in FIG. 5, processing was performed with and without integration. Thus, y₃ indicated at 802 is the series without integration and y₄ indicated at 804 is the series with integration. The series y₃(t) at 802 was calculated with the following equation:

$${y}_{3} ( t ) = \frac{{y}_{2} ( t )}{σ [ {y}_{2} ( t ) ]} \qquad Eq . 4$$

where σ[y₂(t)] is the standard deviation in y₂(t) over a significant period before contact.

In contrast, the series y₄(t) is calculated by first computing a series, y₃(t) (not shown on FIG. 8) with the following equation:

$${y}_{3} ( t ) = {\int }_{t - τ}^{t} {y}_{2} ( t ) ⅆ t . \qquad Eq . 5$$

The integration was performed numerically using point-to-point trapezoid rule. The increment or period, τ, was set to 10 seconds. Using the y₃(t) series generated from Eq. 5, the series y₄(t) as indicated at 804 is generated with the following equation:

$${y}_{4} ( t ) = \frac{{y}_{3} ( t )}{σ [ {y}_{3} ( t ) ]} \qquad Eq . 6$$

where σ[y₃(t)] is the standard deviation in y₃(t) from Eq. 5 over a significant time before contact. The series y₃ and y₄ indicated at 802 and 804, respectively, are dimensionless. The values of y₄ represent multiples of the standard deviation σ from y₃ or integral values. It is apparent from FIG. 8 that the illustrated series y₄ more clearly indicates engagement point than series y₃. For this reason, integration is generally desirable due to cumulative effects.

Using the series y₄(t) indicated as 804, the “upper” limit or bound S₂ of engagement was determined to be the first point for which y₄(t) exceeded 20. Thus, the threshold h₂described above was set at 20 (but could be set as low as 2 as desired). The “lower” limit or bound for the point of engagement S₁ was determined by starting at S₂ and working backward to the first point where the absolute value of y₄(t) is <1, i.e. threshold h₁=1. The point S was acquired from the first point after S₁ where y₄ exceeded 4, i.e. threshold hₛ=4. All three points, S₁, S₂, and S are illustrated on FIG. 8 as 808, 806, and 810 respectively. FIG. 9 generally illustrates the data illustrated on FIG. 6, but graph 900 is an enlargement of data or measurements around the point of engagement S indicated as 602. It is noted that points S₁ and S₂ can be correlated across various series. For example, S₁ and S₂ correlate with 808, 908 and 806, 906 on FIGS. 8 and 9, respectively. Engagement point S correlates with 602, 810 on FIGS. 6, 8 and 9. Finally, it is noted that point S₁ for which there is generally no discernable evidence of engagement or event onset can be obtained by any known means, including but not limited to the means described herein. The point S₁, however determined, is then used in the calculation of engagement point S and/or uncertainty.

Uncertainties corresponding to uncertainty module 408 and block 542 on FIGS. 8 and 9, respectively, were estimated for both force and displacement due to the uncertainty in the determination of the point of contact. A rather conservative estimate of uncertainty can be obtained by taking half the variation in both force and displacement between S₁ and S₂. Thus, uncertainty can be calculated as a function of S₁ and S₂. This method yielded uncertainty estimates of 0.6 μN and 5.6 nm, respectively. A more aggressive estimate of uncertainty is obtained by taking half the variation in force and displacement between the reading immediately before and after the point determined to be the point of engagement S. Thus, uncertainty can also be calculated as a function of S. This method yielded uncertainty estimates in force and displacement of 0.077 mN and 0.68 nm, respectively.

The present inventions, including the method presented in FIG. 5, are advantageous over simple prior art threshold detection because significant event onset (e.g. engagement point) in experimental data can be detected by more sensitive means. The detection means or apparatus also includes a means for determining lower and upper bounds of the range of possible event onset, or S₁ and S₂. The present inventions also include a means for determining the uncertainty in any test parameter due to the uncertainty in the determination of S. Finally, prior knowledge of the pre-event functionality of the data series of interest is not generally required.

Although the present invention has been described with reference to preferred embodiments, workers skilled in the art will recognize that changes may be made in form and detail without departing from the spirit and scope of the invention. For instance, although digitized signals are described herein for processing, analog signals and analog processing can be preferred as appreciated by those skilled in the art.

What is claimed is:

1. A computer readable medium including instructions readable by a computer, which when implemented, cause the computer to detect a significant event in measurement data comprising the steps of:
generating values associated with received measurements, the values indicative of multiples of a standard deviation; and
calculating the significant event as a function of the values.

2. The computer readable medium of claim 1, wherein the significant event is a point of engagement.

3. The computer readable medium of claim 2, wherein the point of engagement is of an indenter in an indenter test system.

4. The computer readable medium of claim 2, wherein the point of engagement is of a tensile test system.

5. The computer readable medium of claim 1, wherein the received measurements are received as a function of at least one variable, and further comprising processing the received measurements to generate the values.

6. The computer readable medium of claim 5, wherein processing the received measurements to generate the values comprises differentiating the received measurements with respect to at least one of the variables to generate a derivative signal scattering about zero as a function of one of the variables.

7. The computer readable medium of claim 5, wherein processing the received measurements to generate the values comprises using a compensation function to zero the received measurements.

8. The computer readable medium of claim 6, wherein processing the received measurements to generate the values comprises integrating the derivative signal over a selected increment to generate an integral signal.

9. The computer readable medium of claim 8, wherein processing the received measurements to generate the values comprises calculating the standard deviation from at least part of the integral signal.

10. The computer readable medium of claim 9, and further comprising dividing the integral signal by the standard deviation to generate the values.

11. The computer readable medium of claim 10, wherein calculating the significant event as a function of the values comprises selecting an upper bound based on the generated values.

12. The computer readable medium of claim 11, wherein the upper bound is selected based on an upper threshold correlating to a selected multiple of the standard deviation.

13. The computer readable medium of claim 11, wherein calculating the significant event as a function of the values comprises selecting a lower bound associated with pre-event measurement data.

14. The computer readable medium of claim 13, wherein calculating the significant event as a function of the values comprises using at least one of the upper bound and the lower bound to identify the significant event.

15. The computer readable medium of claim 10, wherein calculating the significant event as a function of the values comprises identifying the significant event as a point correlating to where the integral signal is approximately 2 to 20 times the standard deviation.

16. The computer readable medium of claim 15, wherein calculating the significant event as a function of the values comprises identifying the significant event as a point correlated to where the integral signal is approximately 4 times the standard deviation.

17. The computer readable medium of claim 5, wherein processing the received measurements to generate the values comprises integrating the received measurements to generate an integral signal.

18. The computer readable medium of claim 17, and further comprising calculating the standard deviation from at least a portion of the integral signal.

19. The computer readable medium of claim 18, and further comprising calculating multiples of the standard deviation by dividing the integral signal by the standard deviation.

20. A computer readable medium including instructions readable by a computer, which when implemented, cause the computer to detect a significant event in data measurements comprising the steps of:
receiving a data series indicative of test measurements as a function of a first variable;
generating at least one processed series from the data series;
identifying a first point on the at least one processed series;
identifying a second point on the at least one processed series;
calculating the significant event as a function of at least one of the first point and the second point.

21. The computer readable medium of claim 20, and further comprising receiving the data series as a function of at least one other variable.

22. The computer readable medium of claim 21, wherein the test measurements indicate force.

23. The computer readable medium of claim 22, wherein the first variable comprises displacement and the at least one other variable comprises time.

24. The computer readable medium of claim 21, wherein generating at least one processed series comprises taking a first derivative of the received data series to generate a first processed series.

25. The computer readable medium of claim 24, wherein generating at least one processed series comprises taking a second derivative of the received data series to generate a second processed series.

26. The computer readable medium of claim 25, wherein generating at least one processed series comprises integrating the second processed series over a selected period to generate a third processed series.

27. The computer readable medium of claim 26, and further comprising calculating a standard deviation for at least a portion of the third processed series.

28. The computer readable medium of claim 27, wherein generating at least one processed series comprises dividing the third processed series by the standard deviation to generate a fourth processed series.

29. The computer readable medium of claim 28, wherein identifying a second point on the at least one processed series comprises identifying a point on the fourth processed series threshold where the significant event is assumed to have already occurred.

30. The computer readable medium of claim 29, wherein identifying a second point on the at least one processed series comprises selecting an upper threshold as a function of the standard deviation.

31. The computer readable medium of claim 30, wherein the upper threshold is a multiple of the standard deviation.

32. The computer readable medium of claim 31, wherein the upper threshold is in the range of approximately 10 to 20.

33. The computer readable medium of claim 29, wherein identifying a first point on the at least one processed series comprises identifying a point on the fourth processed series where the significant event is assumed to have not yet occurred.

34. The computer readable medium of claim 33, wherein identifying a first point on the at least one processed series comprises selecting a lower threshold.

35. The computer readable medium of claim 33, wherein the lower threshold is less than 1.

36. The computer readable medium of claim 21, wherein generating at least one processed series comprises integrating the received data series over a selected increment to generate a first processed series.

37. The computer readable medium of claim 36, wherein generating at least one processed series further comprises calculating a standard deviation for a least a portion of the first processed series.

38. The computer readable medium of claim 37, wherein generating at least one processed series further comprises dividing the first processed series by the standard deviation to generate a second processed series.

39. A method of determining a significant event in experimental data comprising the steps of:
generating a data signal indicative of measurements as a function of at least one variable;
processing the data signal to generate a plurality of processed signals; and
determining a significant event based on the processed data signals.

40. The method of claim 39, wherein the step of processing the data signal to generate a plurality of processed signals comprises taking at least a first derivative of the data signal to generate a processed derivative signal as a function of the at least one variable, wherein a portion of the processed derivative signal fluctuates about zero as a function of the at least one variable.

41. The method of claim 40, wherein the step of processing the data signal to generate a plurality of processed signals comprises integrating the processed derivative signal to generate a processed integral signal as a function of the at least one variable, the processed integral function comprising integral values.

42. The method of claim 41, wherein the step of processing the data signal to generate a plurality of processed signals comprises:
calculating a standard deviation over a portion of the integral signal; and
dividing the integral values by the standard deviation to generate a signal comprising multiples of the standard deviation.

43. The method of claim 42, wherein determining a significant event based on the processed data signals comprises determining the significant event based on the signal comprising multiples of the standard deviation.

44. The method of claim 43, wherein determining the significant event based on the signal comprising multiples of the standard deviation comprises:
selecting an upper bound for the significant event;
selecting a lower bound for the significant event;
determining the significant event as a point bounded by the upper bound and the lower bound.

45. The method of claim 42, and further comprising determining an uncertainty of the significant event as a function of the upper bound and the lower bound.

46. The method of claim 42, and further comprising determining an uncertainty of the significant event based on the point bounded by the upper bound and the lower bound.

47. The method of claim 39, wherein the step of processing the data signal to generate a plurality of processed signals comprises integrating the data signal to generate a processed integral signal as a function of the at least one variable.

48. A testing system comprising the computer readable medium of claim 1.

49. A testing system comprising the computer readable medium of claim 17.

50. A testing system recording measurements and capable of determining a significant event comprising:
a testing apparatus generating a data signal indicative of the measurements recorded as a function of at least one variable; and
a processor coupled to the test apparatus and a computer readable medium storing processor-executable instructions for identifying the significant event, the instructions comprising steps of:
receiving the data signal; and
generating from the received data signal at least one processed signal indicative of a multiple of a standard deviation.
